(19) United States
(12) Patent Application Publication
(10) Pub. No.: US 2018/0282129 A1
(43) Pub. Date: Oct. 4, 2018

(54) PLANAR ELEVATOR CAR ELEMENT FOR AN ELEVATOR INSTALLATION

(71) Applicants: THYSSENKRUPP ELEVATOR AG, Essen (DE); thyssenkrupp AG, Essen (DE)

(72) Inventors: Michael KIRSCH, Kirchheim unter Teck (DE); Walter HOFFMANN, Niedernhausen (DE); Christoph PAWELSKI, Dresden (DE); Mike OBERT, Gernsbach (DE); Philippe GAINCHE, Großbettlingen (DE)

(73) Assignees: THYSSENKRUPP ELEVATOR AG, Essen (DE); thyssenkrupp AG, Essen (DE)

(21) Appl. No.: 15/763,182

(22) PCT Filed: Sep. 7, 2016
(86) PCT No.: PCT/EP2016/071107

§ 371 Date: Mar. 26, 2018

(30) Foreign Application Priority Data
Sep. 24, 2015 (DE) 10 2015 218 401.3

(51) Int. Cl. B66B 13/30; B66B 11/02; B32B 7/02; B32B 27/20; B32B 3/02; B32B 37/18

(52) U.S. Cl. CPC B66B 13/303; B66B 11/0226; B66B 11/0233; B32B 37/182; B32B 27/20; B32B 3/02; B32B 7/02

(57) ABSTRACT

A planar elevator car element for an elevator installation may include a first cover layer, a second cover layer, and an intermediate layer. The intermediate layer may have a lesser density than the first cover layer. Furthermore, the planar elevator car element may include a frame profiled element disposed along at least one of its edges, which is positioned between the first cover layer and the second cover layer. In some examples, the frame profiled element extends around multiple edges of the planar elevator car element. In a method for producing the planar elevator car element, a stack involving the first cover layer, the second cover layer, the intermediate layer, and the frame profiled element may be heated and thereby joined into a structural part.

Elevator installations serve for the delivery of passengers between various floors of a building. For this purpose, an elevator car is moved between the floors inside an elevator shaft. Classically, the elevator car is connected by a cable to a counterweight for this purpose, wherein the cable runs across a driven traction sheave. Alternative elevator installations, on the contrary, no longer use any counterweights and are driven for example with linear motors. In these elevator installations, therefore, the weight of the elevator car cannot be balanced out by the counterweight. Consequently, it is advantageous to reduce the weight of all the elevator car components. For example, the weight of the door leaf and the wall panels is reduced by using new materials, such as carbon composites or sandwich sheets.

The use of sandwich sheets in elevator construction is known for example from CN102745580. An overview of sandwich designs is provided by WO2005/113230.

Starting from this prior art, the object of the invention is to provide a planar elevator car element which on the one hand is very light, yet on the other hand is also easy to handle and is installed with no problems.

This problem is solved by a planar elevator car element for an elevator installation comprising a first cover layer, a second cover layer and an intermediate layer, which is arranged between the first cover layer and the second cover layer, wherein the intermediate layer has a lesser density than the first cover layer. The planar elevator car element comprises a frame profiled element along at least one of its edges, which is arranged between the first cover layer and the second cover layer. The known sandwich design of two cover layers and a light intermediate layer located in between results in a planar elevator car element which is both light and also has an adequate stability. In the area of the edges, however, such an elevator car element is relatively sensitive, because the intermediate layer lies exposed here. Thus, damage can easily occur when handling the elevator car element, such as breaking off, for example. The frame profiled element at the edge ensures an adequate stability also in the area of the edges for an uncomplicated handling during production, storage and installation. Especially in regard to the installation, the frame profiled element affords the additional advantage that fastening elements for the planar elevator car element can engage from any given direction with the frame profiled element, for example even parallel to a direction of extension of the planar elevator car element (i.e., perpendicular to one of the narrow side surfaces).

The arrangement of the frame profiled element between the first cover layer and the second cover layer has the additional advantage that the frame profiled element can be easily integrated directly in the elevator car element during the production of the planar elevator car element. In one possible production method, the first cover layer, the second cover layer and the intermediate layer together with the frame profiled element are arranged in a stack. This stack is then heated under pressure, so that the first cover layer, the second cover layer, the intermediate layer and the frame profiled element are joined into a structural part. Thus, the frame profiled element need not be joined by additional fastening elements to the cover layer. By ways of heating under pressure, the cover layers fuse with the frame profiled element, resulting in a stable connection of frame profiled element and cover layers.

A further benefit of the arrangement of the frame profiled element between the first cover layer and the second cover layer is that the frame profiled element is not visible to a passenger in the elevator car. The passenger sees only a uniform surface, formed by the first or the second cover layer.

By a planar elevator car element is meant in the sense of this application a sheetlike construction element which is used in the construction of elevator cars for an elevator installation. In particular, it may involve wall panels from which the cabin space is constructed. Furthermore, it may also involve a door leaf for an elevator car door.

In particular, the first cover layer and/or the second cover layer comprises a fiber-reinforced plastic. This may be a carbon fiber plastic (CFK), glass fiber plastic (GFK) or aramid fiber plastic (AFK). Fiber-reinforced plastics with natural fibers are also possible. The plastic is typically polyurethane, epoxy resin, polyester, vinyl ester or a hybrid resin. The plastics may furthermore be combined with additives such as flame protectants (e.g., based on aluminum trihydrate, alumina hydrate or phosphorus), carbon nanotubes for improved conductivity, core-shell particles for hardening, or reactive thinners.

Alternatively, aluminum may also be contained in the first and/or second cover layer. Such materials have already been tested for sandwich constructions and exhibit the necessary long life for elevator cars of an elevator installation. The intermediate layer, on the other hand, typically comprises hard foams, high-performance foams (PET, PVC), end-grain balsa, polyethylene foams, metal foam or a honeycomb material. Honeycombs may consist of both metallic and nonmetallic substances. In particular, folded honeycombs of paper or cardboard as well as cork can be used.

In one special embodiment of the planar elevator car element, a structural part is integrated in the frame profiled element. This has the benefit that the structural part is disposed invisibly to the passenger of the elevator car, since the frame profiled element is concealed by the cover layers. Furthermore, this makes possible an especially space-saving arrangement of the structural part. Moreover, the structural part may be integrated in the frame profiled element already during the production of the planar elevator car element. For this purpose, the construction element is installed in the at first still separate frame profiled element. During the production of the planar elevator car element according to the specified production method (layering and heating under pressure), this produces a planar elevator car element which is already outfitted with the required structural parts, so that further installation steps may be omitted.

The structural part may be a light grid, in particular. By a light grid is meant light emitting or light receiving components which are used in the area of an elevator car door. For example, these are light barriers used to ensure that no passenger is situated in the door area upon closing of the elevator car door. Furthermore, this is also understood to mean light emitting components which are mounted in the area of the door interior and emit a light signal as a warning function or for purely decorative reasons.

Furthermore, the structural part may be a cable duct. By way of the cable duct, the aforementioned light grid may be supplied with energy, for example. But the integration of a cable duct in the frame profiled element also has distinct benefits when the planar elevator car element is used as a wall panel. For example, when the elevator car is assembled from a plurality of planar elevator car elements according to the invention, cable routing results automatically, by which each area of the elevator car can be reached. Thus, control lines and power supply lines can be laid to input devices with no major expense.

In one modified variant embodiment, the intermediate layer comprises a first recess and the first cover layer comprises a second recess, wherein the second recess is arranged in the region of the first recess and wherein a component is accommodated in the first recess. This layout has the advantage that the planar elevator car element is designed as an integrated structural part, in which an additional functional component is embedded. For this purpose, an installation space is provided inside the intermediate layer in the form of the first recess to receive the component. Furthermore, the first cover layer comprises an aperture in the form of the second recess, which is situated in the region of the first recess. Consequently, the component is not entirely covered by the first cover layer, so that a connection to other structural parts of the elevator car can be easily made. This layout has the further benefit that the component can be integrated already during the production of the planar elevator car element. For this purpose, in the production method described above, the first recess is already provided in the intermediate layer and the second recess in the first cover layer. When the material stack is formed, the component is then already inserted in the first recess and second recess. By way of heating under pressure, the layers and the component bind together to form an integrated structural part. One example of such a construction is a door leaf as a planar elevator car element with a coupling element for connecting the door leaf to another door leaf. This connection is used in the case of sliding doors with an inner door leaf and an outer door leaf. The two door leaves of the sliding door are in this case coupled together in a middle region.

In one modification of this variant embodiment, the second recess is covered at least partly by a reinforcing element. This partial closure of the second recess means that the planar elevator car element regains at least some of its stability which was lost on account of the aperture of the second recess in that area.

In another modified variant embodiment, the intermediate layer comprises a first recess and the first cover layer comprises an indentation, wherein the indentation is arranged in the region of the first recess and wherein a component is accommodated in the indentation. This variant has the benefit that no aperture is required in the first cover layer. An indentation is only made in the first cover layer during the production process, which necessarily produces a first recess in the intermediate layer. Consequently, the stability of the planar elevator car element is improved, since no recess is present in the first cover layer. At the same time, however, an additional component may be arranged in the indentation, in order to integrate additional functions in the planar elevator car element, yet still ensuring a flat overall contour for the planar elevator car element. The component is embedded in the indentation so that it does not project beyond the flat plane of the principal extension of the planar elevator car element.

In one modification of this variant embodiment, the indentation is covered at least partly by a reinforcing element. This partial closure of the indentation means that the planar elevator car element regains at least some of its stability which was lost on account of the indentation in that area.

Another possibility for increasing the stability in the area of the component is that the component is embedded in a reinforcing material. Basically any material can be used for this which is both lightweight and stable. One exemplary possibility for this is balsa wood, which on the one hand is light and stable, but on the other hand can also be easily worked in order to adapt to the shape of the component.

Alternatively or in addition, the stability can be increased in the area of the component in that the second cover layer comprises a reinforcement, situated opposite the first recess. For example, the second cover layer may be thickened in this area or provided with an additional layer for the reinforcement. Fiber-reinforced plastics may also be considered in particular for the additional layer.

The invention furthermore relates to an elevator car for an elevator installation with a planar elevator car element as described above.

In particular, such an elevator car may be modified in that the elevator car comprises two such adjacently disposed planar elevator car elements, wherein at least one reinforcing element is provided, which extends across the two adjacently disposed planar elevator car elements. In this way, the stability of the elevator car can be even further improved. The reinforcing element may be, for example, a reinforcing web, which joins together and strengthens several planar elevator car elements.

Alternatively, the reinforcing element may also be strip-shaped (that is, in the sense of a tape). Such a reinforcing element may subsequently be added especially easily during the installation. In particular, such a reinforcing element may be laminated in place, so that an especially stable connection is achieved between the planar elevator car elements and the reinforcing element. In particular, the reinforcing element in both variants (reinforcing web, strip shape) may contain a fiber-reinforced plastic.

The invention shall be explained more closely with the aid of the figures. There are shown

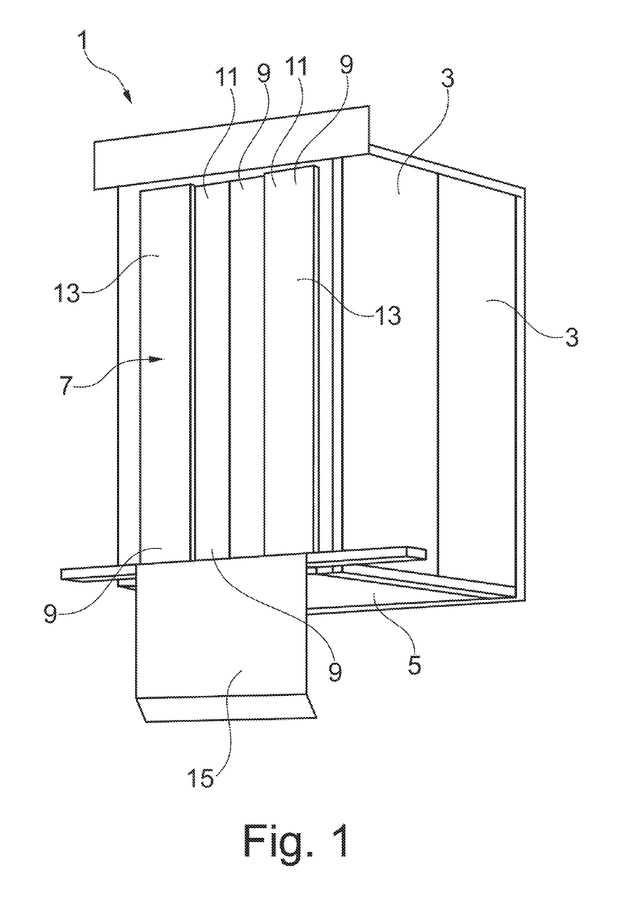

FIG. 1, a three-dimensional schematic representation of an elevator car;

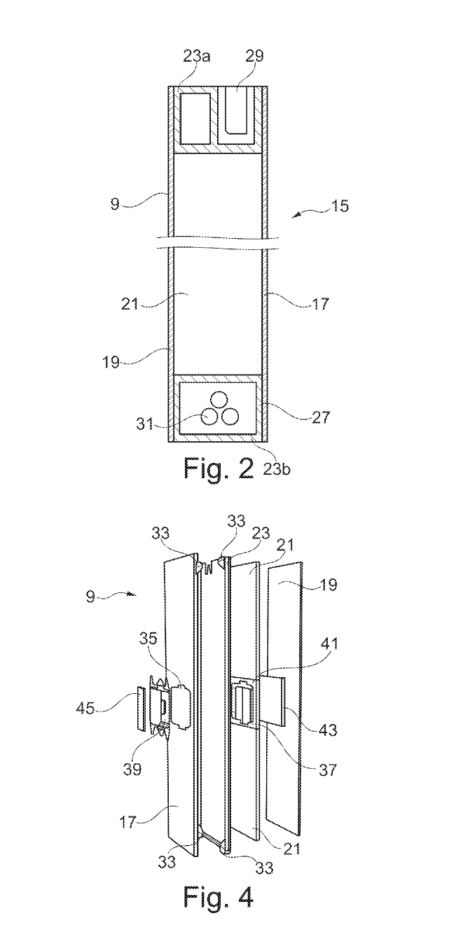

FIG. 2, a cross section through a planar elevator car element;

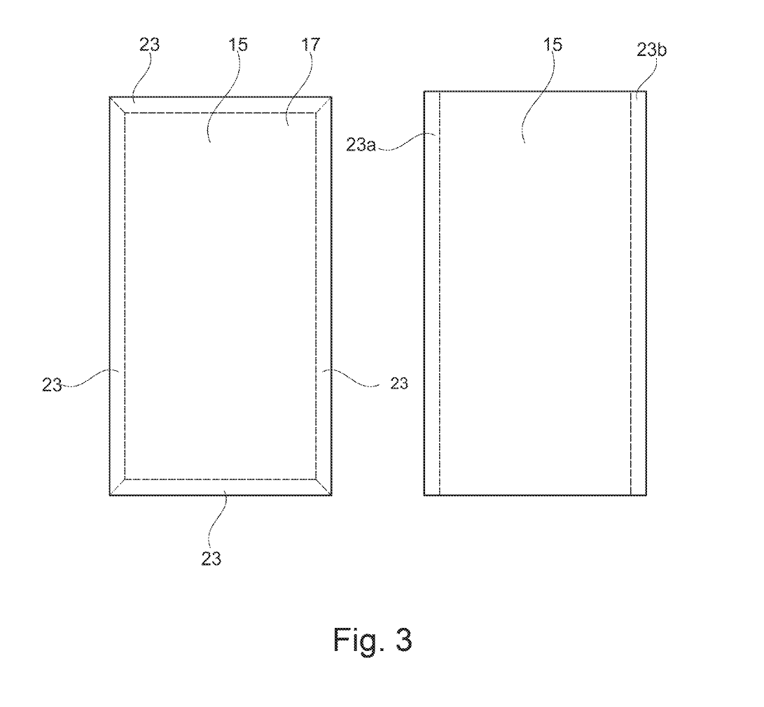

FIG. 3, a side view of the planar elevator car element in two variant embodiments;

FIG. 4, an exploded view of a door leaf according to the invention;

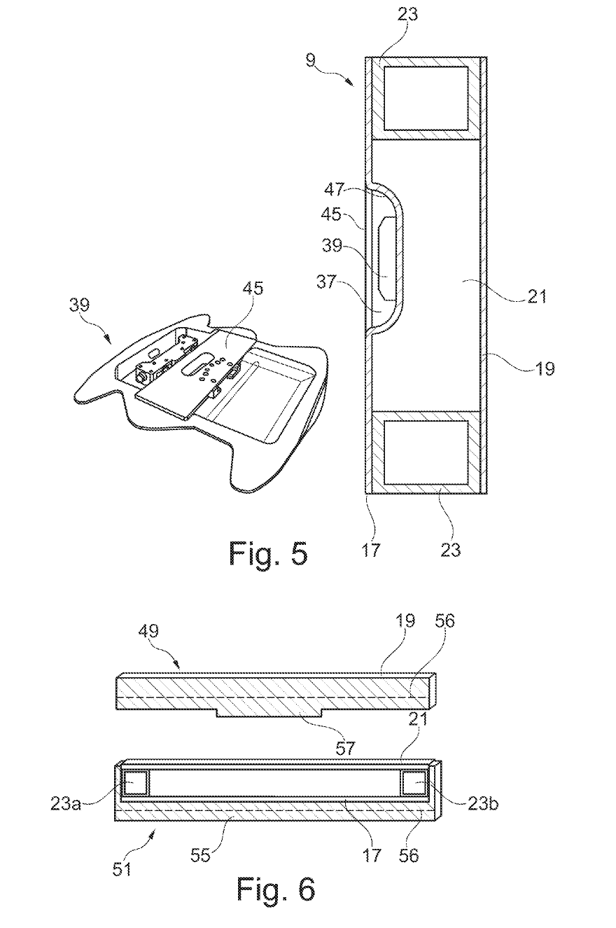

FIG. 5, a cross section through a door leaf in an alternative variant embodiment;

FIG. 6, a schematic representation of a press for production of a planar elevator car element according to the invention;

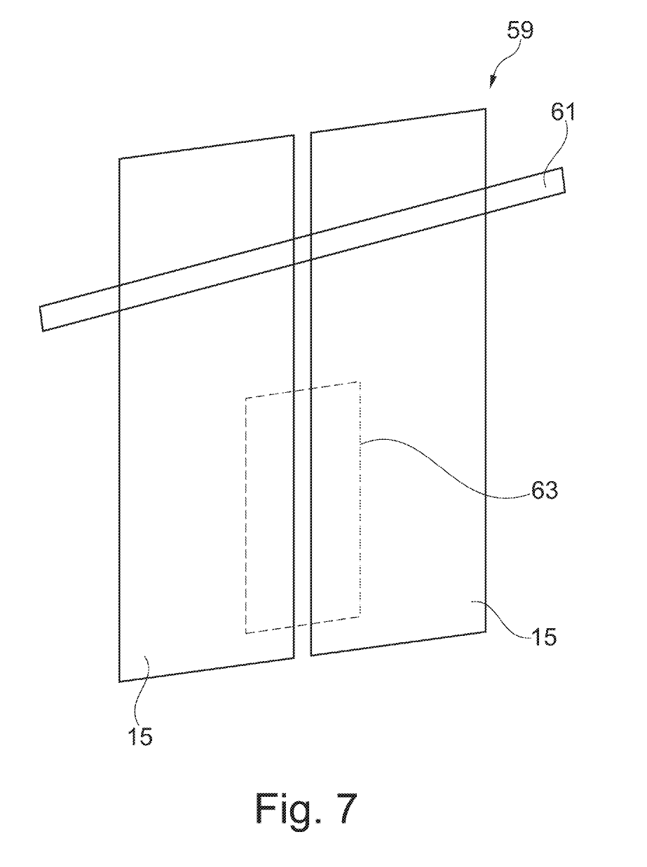

FIG. 7, a schematic representation of an elevator car wall.

FIG. 1 shows a three-dimensional representation of an elevator car 1 for an elevator installation. The elevator car 1 comprises several wall panels 3, as well as an elevator car floor 5 and an elevator car ceiling. In the front area, the elevator car 1 is outfitted with an elevator car door 7. The elevator car door 7 is designed as a sliding door on either side and comprises four door leaves 9 (two inner door leaves 11 and two outer door leaves 13). In the lower area of the elevator car door 7 there is mounted an elevator car apron 16. Both the door leaves 9 and the wall panels 3 are designed as a planar elevator car element according to the invention, as is described more closely with the aid of the following drawings.

FIG. 2 shows a cross section through a planar elevator car element 15, for example a door leaf 9. The planar elevator car element 15 comprises a first cover layer 17, a second cover layer 19 and an intermediate layer 21, which is arranged between the first cover layer 17 and the second cover layer 19. The intermediate layer 21 here has a lesser density than the first cover layer and the second cover layer. Thus, it involves a so-called sandwich construction, in which an intermediate layer 21 of lesser density is enclosed by two more stable layers of higher density. This construction has the benefit of producing a very light, yet still stable planar elevator car element 15. For this purpose, the first cover layer and/or the second cover layer contain a fiber-reinforced plastic. In particular, this may be a carbon fiber plastic (CFK), glass fiber plastic (GFK) or aramid fiber plastic (AFK). Alternatively, fiber-reinforced plastics with natural fibers can also be used. The plastic is typically polyurethane. Other plastics are likewise possible. As a further variant, the first cover layer and/or the second cover layer may contain aluminum or another light metal. The intermediate layer 21 with lesser density preferably comprises a plastic foam.

Along two edges the planar elevator car element 15 comprises two frame profiled elements 23a, 23b. The two frame profiled elements 23a and 23b are arranged in this case between the first cover layer 17 and the second cover layer 19. In a side view of the planar elevator car element 15, the observer consequently sees only one of the cover layers 17 or 19. The frame profiled elements 23a, 23b cannot be recognized when viewed from the side. Thus, a uniform surface is presented to the viewer. The frame profiled elements 23a, 23b have the function of strengthening and stabilizing the edge along which they extend. Furthermore, the frame profiled elements 23a, 23b serve to ensure a simple installation of the planar elevator car element 15 when assembling the elevator car 1. For example, adjacently disposed planar elevator car elements 15 may be joined together by screws or other connection means engaging with the respective frame profiled elements 23a, 23b of the planar elevator car elements 15. The frame profiled elements 23a, 23b are typically designed as hollow profiles, so that they are both relatively light and also provide a sufficient stability to the planar elevator car element 15.

Moreover, FIG. 2 shows a structural part 25a which is integrated in the frame profiled element 25a. The structural part 25a constitutes a light grid 29. Along the opposite edge, the planar elevator car element comprises a frame profiled element 23b in which a cable duct 27 is integrated. Through the cable duct 27 is led a cable 31, which connects the light grid 29 to a power source.

FIG. 3 shows as an example a side view of two planar elevator car elements 15. In this view, only the first cover layer 17 is recognizable to the viewer. Behind the first cover layer the two planar elevator car elements 15 each comprise frame profiled elements. Since the frame profiled elements are not visible, they are indicated by broken lines in FIG. 3. While the left planar elevator car element 15 comprises a frame profiled element 23, which extends around the edges of the elevator car element 15, the right planar elevator car element 15 comprises two frame profiled elements 23a, 23b, which extend along opposite edges of the planar elevator car element 15.

FIG. 4 shows an exploded view of a door leaf 11 according to the invention. In particular, this constitutes an inner door leaf 11 of a sliding door. The door leaf 11 is one variant of a planar elevator car element 15. The door leaf 11 comprises a first cover layer 17 and a second cover layer 19. Between the first cover layer 17 and the second cover layer 19 is arranged an intermediate layer 21. A frame profiled element 23 is arranged around the edges of the door leaf 9. At the corners, additional stiffeners 33 are placed. The stiffeners 33 serve at the same time as mounting elements for connecting the door leaf 9 to neighboring components. In the middle, the intermediate layer 21 of the door leaf 11 comprises a first recess 37. The first cover layer 17 comprises a second recess 35 in the region of the first recess 37. A component 39 is received in the first recess 37. In this case, the component 39 extends through the second recess 35 in the first cover layer 17 and is received in the first recess of the intermediate layer 21. The component 39 is embedded in a reinforcing material 41. Since the intermediate layer 21 has a lesser density and comprises, for example, a plastic foam, the intermediate layer 21 is too soft to enable a stable fastening of the component 39. This function is performed by the reinforcing material 41, which joins the component 39 to the two more stable cover layers 17 and 19. Due to the second recess 35 in the first cover layer 17, the stability of the door leaf 11 is reduced in the region of the second recess 35. In order to compensate for this, at least in part, the second cover layer 19 comprises a reinforcement 43, situated opposite the second recess 35 of the first cover layer 17. Alternatively or additionally, the second recess 35 may be covered at least partly by a reinforcing element 45. In the present case, the reinforcing element 45 covers the second recess 35 again, at least for a portion, so that the first cover layer 10 regains at least a portion of its stability which it lost because of the second recess 35. The component 39 in the variant represented in FIG. 4 is a coupling element for connecting an inner door leaf of a sliding door to the corresponding outer door leaf of the sliding door.

FIG. 5 shows an alternative variant embodiment of a door leaf 9. The door leaf comprises a first cover layer 17, a second cover layer 19 and an intermediate layer 21, which is arranged between the first cover layer 17 and the second cover layer 19. Along the opposite edges of the door leaf 9, the door leaf 9 comprises a frame profiled element 23, which is arranged between the first cover layer 17 and the second cover layer 19. In the middle, the intermediate layer 21 comprises a first recess 37 and the first cover layer 17 comprises an indentation 47, the indentation 47 being arranged in the region of the first recess 37. A component 39 is received in the indentation 47. Unlike the variant embodiment of FIG. 4, in this case the first cover layer 17 is not pierced by a second recess. Instead, an indentation 47 was impressed in the first cover layer 17 during the production of the door leaf. The component 39 is arranged at the site of this indentation 47, so that the component 39 is in contact with the deepened region of the first cover layer 17. This has the advantage that the reinforcing material 41 (see FIG. 4) can be omitted. Of course, the reinforcing material 41 can be arranged additionally between the first cover layer 17 and the second cover layer 19 in the area of the indentation 47. The impression of an indentation 47 also results in a certain structural weakening of the door leaf 9 in this region, so that an additional reinforcement may be required. In the variant of FIG. 5, the indentation 47 is partly covered by a strip-shaped reinforcing element 45 for additional reinforcement. The reinforcing element 45 is situated in a plane with the other portion of the first cover layer 17 and as it were partly closes once more the region of the indentation 47.

The component 39, shown enlarged at the left side of FIG. 5, is a coupling element for connecting an inner door leaf of a sliding door to the corresponding outer door leaf of the sliding door.

FIG. 6 shows schematically a press 49 for production of a planar elevator car element according to the invention. In a pressing area 51 of the press 49, there have been arranged in a stack a first cover layer 17, a second cover layer 19, an intermediate layer 21 and two frame profiled elements 23a and 23b, with the frame profiled elements 23a and 23b each extending along at least one edge of the stack. During the production process, the stack is pressed against the mold 55 with the aid of the upper stamp 53. At the same time, both the stamp 53 and the mold 55 are heated above the melting point of the respectively adjacent cover layer with the aid of the heating device 56. During the pressing process, therefore, the first cover layer and the second cover layer fuse with the components situated in between. In this way, the entire stack is joined into a structural part. This production process may involve additional method steps, depending on the more precise configuration of the planar elevator car element. For example, in order to produce the planar elevator car element 9 shown in FIG. 4, the reinforcing material 41 and the reinforcement 43 are also introduced into the stack being compressed. The component 39 and the reinforcing element 45 may likewise be inserted into the stack being compressed or they can also be mounted later on after the pressing process. For example, when producing the planar elevator car element 9 shown in FIG. 5, the indentation 47 is first produced during the pressing process, for example. For this purpose, the upper stamp 53 comprises the corresponding bulge 57. The first cover layer 17 and the second cover layer 21 may alternatively be cut to exact size before the pressing process or also be provided with an edge overflow. In the second case, the planar elevator car element is further machined after the pressing process in order to ensure a sharp edge contour.

FIG. 7 shows a schematic representation of an elevator car wall 59 with two adjacently disposed planar elevator car elements 15 in the form of wall panels. Two reinforcing elements extend across the two adjacently disposed planar elevator car elements 15. The upper reinforcing element is designed in the form of a reinforcing web 61. This is bonded over a large area to the two planar elevator car elements 15, such as by gluing. In the lower region, for example, a strip-shaped reinforcing element 63 is shown. This is likewise bonded over a large area to the two planar elevator car elements 15, especially by lamination.

### LIST OF REFERENCE SIGNS

Elevator car 1
Wall panel 3
Elevator car floor 5
Elevator car door 7
Door leaf 9
Inner door leaf 11
Outer door leaf 13
Planar elevator car element 15
Elevator car apron 16
First cover layer 17
Second cover layer 19
Intermediate layer 21
Frame profiled element 23a,23b
Structural part 25a,25b
Cable duct 27
Light grid 29
Cable 31
Stiffeners 33
Second recess 35
First recess 37
Component 39
Reinforcing material 41
Reinforcement 43
Reinforcing element 45
Indentation 47
Press 49
Pressing area 51
Stamp 53
Mold 55
Heating device 56
Bulge 57
Elevator car wall 59
Reinforcing web 61
Strip-shaped reinforcing element 63

1.-13. (canceled)

14. A planar elevator car element for an elevator installation comprising:
a first cover layer;
a second cover layer;
an intermediate layer disposed between the first cover layer and the second cover layer, wherein the intermediate layer has a lesser density than the first cover layer; and
a frame profiled element disposed along an edge between the first cover layer and the second cover layer.

15. The planar elevator car element of claim 14 wherein the frame profiled element extends around multiple edges of the planar elevator car element.

16. The planar elevator car element of claim 14 comprising a structural part that is integrated in the frame profiled element.

17. The planar elevator car element of claim 14 wherein the structural part is a cable duct.

18. The planar elevator car element of claim 14 wherein the structural part is a light grid.

19. The planar elevator car element of claim 14 wherein the intermediate layer comprises a first recess and the first cover layer comprises a second recess, wherein the second recess is disposed in a region of the first recess, wherein a component is received in the first recess.

20. The planar elevator car element of claim 19 wherein the second recess is covered at least in part by a reinforcing element.

21. The planar elevator car element of claim 19 wherein the component is embedded in a reinforcing material.

22. The planar elevator car element of claim 19 wherein the second cover layer comprises a reinforcement disposed opposite the first recess.

23. The planar elevator car element of claim 14 wherein the intermediate layer comprises a first recess and the first cover layer comprises an indentation, wherein the indentation is disposed in a region of the first recess, wherein a component is received in the indentation.

24. The planar elevator car element of claim 21 wherein the indentation is covered at least in part by a reinforcing element.

25. The planar elevator car element of claim 21 wherein the component is embedded in a reinforcing material.

26. The planar elevator car element of claim 21 wherein the second cover layer comprises a reinforcement disposed opposite the first recess.

27. An elevator car for an elevator installation with two adjacently disposed planar elevator car elements, wherein each of the adjacently disposed planar elevator car elements comprises:
a first cover layer;
a second cover layer;
an intermediate layer disposed between the first cover layer and the second cover layer, wherein the intermediate layer has a lesser density than the first cover layer; and
a frame profiled element disposed along an edge between the first cover layer and the second cover layer.

28. A method for producing a planar elevator car element comprising an intermediate layer disposed between a first cover layer and a second cover layer, with the intermediate layer having a lesser density than the first cover layer, and a frame profiled element, the method comprising:
positioning the first cover layer, the second cover layer, the intermediate layer, and the frame profiled element in a stack so that the frame profiled element and the intermediate layer are between the first and second cover layers, with the frame profiled element being disposed along an edge; and
heating the stack under pressure such that the first cover layer, the second cover layer, the intermediate layer, and the frame profiled element are joined into a structural part.
